(19) United States
(12) Patent Application Publication
(10) Pub. No.: US 2007/0215831 A1
(43) Pub. Date: Sep. 20, 2007

(54) Stem Sealing Arrangement for a Device Containing Fluid Under Pressure

(75) Inventor: Sergio Carrara, Sarnico (Bergamo) (IT)

Correspondence Address: SHOEMAKER AND MATTARE, LTD, 10 POST OFFICE ROAD - SUITE 110, SILVER SPRING, MD, 20910, US

(73) Assignee: CARRARA S.P.A., Adro (Brescia) (IT)

(21) Appl. No.: 11/687,140

(22) Filed: Mar. 16, 2007

(30) Foreign Application Priority Data
Mar. 17, 2006 (IT) BS2006A000062

(51) Int. Cl. F16K 31/44

(52) U.S. Cl. 251/214

(57) ABSTRACT

The present invention relates to an on-off valve provided with sealing means for the control stem. The sealing means comprise a plurality of sealing rings of expanded graphite and a gland device for placing said rings in compression. The sealing means further comprise a further active element arranged on the bottom wall, provided with an expansion room wherein the fluid pressure causes a thrust action towards said sealing ring. Said sealing means distribute the strain state of the compressed rings in an optimum manner.

### BACKGROUND OF THE INVENTION

1. Field of the Invention

The present invention relates to a functional device, such as a valve, a piston-cylinder system, or a rotatable shaft, provided with sealing means between a stem of the device, for example a rotatable or moving stem, and a wall of a chamber under pressure of the device, from which the stem protrudes.

More in particular, the present invention relates to a valve having a control stem, for example connected to an handle for the manual opening/closing of the valve, provided with sealing means between the stem and the wall of the chamber under pressure from which the stem protrudes.

2. Brief Description of the Prior Art

Generally, a valve that can be manually actuated for opening or closing exhibits a chamber under pressure where the valve opening/closing device is housed.

The opening/closing device is connected to a stem that protrudes from the chamber for being connected to a manually actuable handle.

Sealing means must be provided between the stem and the wall of the opening through which the stem protrudes, to prevent the venting or the leaking of the fluid under pressure from the chamber.

Generally, the sealing means consist of a set of piled sealing rings, fitted on the stem and housed in the gap between the stem and the opening wall.

On the side facing the chamber, the sealing rings rest on a projection of the wall, whereas on the other side, that is, outside the chamber, they are pressed by compression device, which in the jargon is called “gland”.

The rings are generally made of expanded graphite, having strong elastic deformation properties. The axial compression exerted by the gland causes a radial expansion of the rings towards the stem.

The elastic action of the rings on the stem ensures the seal against the fluid venting or leaking.

Experimental measures and theoretical considerations show that the top rings, that is, those close to the gland, are in a condition of strong compression and strong radial expansion, whereas the bottom rings, that is, those close to the wall projection, are in a condition of poor compression and poor radial expansion.

Such uneven distribution of the compression is the cause of several disadvantages.

In order to obtain a useful sealing action also by the bottom rings, it is necessary to provide high tightening loads of the gland bolts, while overloading the top rings.

It has been found that over time, the elastic response of expanded graphite rings tends to decrease due to a sort of “habit” of the material. In other words, the prolonged state of compression the rings are subject to generates a re-arrangement of the lamellar structure of the material, so that it relaxes and loses the elastic characteristics thereof, thus nullifying the sealing action on the stem.

Such relaxation is quicker when the state the material has been subject to is higher, and so the condition of high compression of the rings, and in particular of the top rings, is strongly undesired.

Moreover, too high sealing action of the top rings on the stem causes a torque resistant to the stem rotation which causes a difficult controllability of the stem itself.

Such disadvantages have been dealt with using very low density graphite rings to be installed with a controlled tightening of the gland bolts, or using trapezoidal section rings or using Belleville washers on the gland bolts.

However, none of the solutions proposed so far solves the problems mentioned above, especially due to the fact that they try to oppose the effects of the material relaxation, which occurs in any case, without avoiding the occurrence of the phenomenon itself.

A known solution is disclosed, for example, in document DE3937956, which refers to a partly underground valve with a control stem intended for being rotated, which is sealingly mounted with a usual set of sealing rings with gland, provided with a system for using such sealing rings in said partly underground valve.

A further solution is disclosed, for example, in document U.S. Pat. No. 5,398,944, which refers to the field of oil pumps, wherein a stem is moving and sealingly mounted by sealing rings arranged in a conventional manner.

An even further solution is disclosed in document US 2003/0052457, relating to a sealing system for steam turbines, particularly efficient only when there exists a high pressure that influences the ring.

### SUMMARY OF THE INVENTION

The object of the present invention is to provide a functional device with such sealing means as to ensure a better distribution of the strain state of the sealing rings, in all the operating conditions of the device.

Such object is achieved by a functional device comprising sealing means having at least one active element arranged so as to be directly influenced by the action of the fluid pressure into said chamber, wherein said active element has at least one expansion room wherein the fluid pressure causes a thrust action of said active element towards said sealing ring.

### BRIEF DESCRIPTION OF THE DRAWINGS

FIG. 1 shows a partly section view of an on-off valve comprising sealing means according to the present invention, in accordance with an embodiment variation.

FIGS. 2a to 2h show a diagram of further embodiments of sealing means according to the present invention.

FIG. 3a shows a graph showing a diagram of distribution of the compression strain in conventional sealing means.

FIG. 3b shows a graph showing an example of diagram of distribution of the compression strain in sealing means according to the present invention.

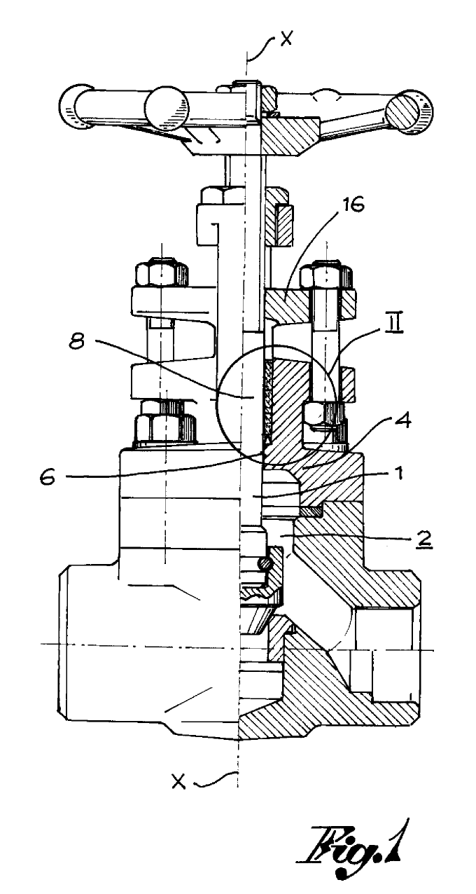

### DESCRIPTION OF THE PREFERRED EMBODIMENT

With reference to the annexed figures, reference numeral 1 denotes a stem of a functional device.

Said functional device is, for example, a valve or a cylinder-piston system, or said stem is a rotatable shaft of said functional device.

Stem 1 has a stem axis X-X, along which said stem exhibits prevailing extension.

In the following description, with reference to the direction of said stem axis X-X, reference shall be made to an “axial” direction, meaning a direction parallel to said stem axis X-X, and to a “radial” direction meaning a direction laying on a plane perpendicular to said stem axis X-X.

Moreover, for clarity of description, in the following description explicit reference is made to an on-off valve by way of an example.

The valve exhibits a chamber 2 wherein there is a fluid under pressure, according to the use of the valve. In the case of an on-off valve of an extraction system, said fluid is a mixture of hydrocarbons, or in the case of an on-off valve of an oil-pressure system, it is oil.

Chamber 2 of the valve is at least partly delimited by a wall 4 having an opening 6 towards the exterior of chamber 2.

The valve is associable to an upstream duct and to a downstream duct and comprises an opening/closing device suitable for allowing/preventing the fluid flow from said upstream duct to said downstream duct.

The opening/closing device is seated into chamber 25 and is operatively connected to stem 1 for manual actuation.

Stem 1 therefore is at least partly seated in chamber 2 and protrudes outwards thereof crossing wall 4 at opening

Preferably, the valve comprises an actuating knob, accessible from the outside by an operator, for example a small ring, operatively connected to stem 1 for operating the opening/closing device.

In particular, stem 1 comprises a sealing portion 8 arranged through said opening 6, defining a gap with the wall that delimits opening 6.

The valve further comprises sealing means suitable for providing a seal to said fluid under pressure between said stem 1 and said wall 4 of chamber 2.

The sealing means comprise at least one sealing ring 12 fitted on stem 1.

Said sealing ring exhibits an inner radial surface 12a, axially facing stem 1, and an outer radial surface 12b, radially spaced and generally concentric to the inner radial surface 12a.

To this end, a longitudinal plane is defined as containing the stem axis X-X and “longitudinal section” of the sealing ring is defined as the section of said ring determined on said longitudinal plane. Said longitudinal section generally is rectangular.

The longitudinal section of the ring is radially determined by the traces on said longitudinal plane of the inner radial surface 12a and of the outer radial surface 12b of said ring. Moreover, the centre line of the longitudinal section of the ring is defined as the imaginary median line between the traces on said longitudinal plane of the inner radial surface 12a and of the outer radial surface 12b of said ring.

Preferably, the sealing means comprise a plurality of sealing rings 12, axially piled and operatively connected to one another.

With reference to the axial position taken by the sealing rings 12, rings 12 close to chamber 6 are indicated as “bottom” rings, and the rings close to the outer environment are indicated as “top” rings.

Preferably, the sealing rings are arranged in the gap between the sealing portion 8 of stem 1 and the wall that delimits opening 6.

The sealing rings 12 are made of a sealing material, such as graphite, having high elastic deformation properties.

According to a preferred embodiment, said rings 12 comprise rings made of sintered graphite and annular graphite braids.

Moreover, the sealing means comprise an abutment wall 14 suitable for forming an abutment for said sealing rings 12.

For example, said valve comprises a flange 16 coupled to wall 4 outside chamber 6, for example by stud bolts. Flange 16 comprises an active portion 18 inserted into opening 6. Said active portion 18 forms said abutment wall 14 for rings 12.

In other words, said flange 16 and said stud bolts form a gland device.

In a preferred embodiment, ring 12 made as an annular braid is indirect abutment with the abutment wall 14.

Said sealing means further comprise at least one active element 20, for example shaped as a ring, arranged so as to be directly influenced by the action of the fluid pressure into said chamber 6. Said active element 20 exhibits at least one expansion room 22 wherein fluid pressure causes a thrust action of said active element 20 towards said sealing ring 12.

According to a preferred embodiment, the active element 20 exhibits a top surface 24 in contact with the sealing ring 12 and a bottom surface 26, axially opposite the top surface 24, wherein the expansion room 22 opens.

If said sealing means comprise a plurality of sealing rings, the sealing ring in contact with said active element 20 is called “first sealing ring”.

Preferably, the expansion room 22 is annular and annularly uninterrupted.

The active element 20 is structurally suitable for causing a thrust action towards the sealing ring 12. In other words, the active element 20 is formed so as to absorb, for example by deformation thereof, the entire action of the fluid pressure but, opposing such deformation, it transmits at least part of such action to the sealing ring 12.

In particular, the active element 20 exhibits compression deformation that is less than the compression deformation of the sealing ring 12, strain conditions being equal, for example due to the material of which it is made.

For example, the active element is made of steel, whereas the sealing element is made of graphite. In other words, the material of the active element exhibits a compression deformation which is less than the compression deformation of the material of which the sealing ring is made, strain conditions being equal.

Said sealing means further comprise a bottom wall 30, inside chamber 2, at least partly radially protruding from wall 4 that delimits opening 6.

The bottom wall 30 exhibits an end surface 32 radially delimits it and is axially facing stem 1.

The sealing ring 12 and the active element 20 are arranged between the abutment wall 14 and the bottom wall 30 and in particular, the active element 20 directly rests on the bottom wall 30.

The expansion room 20 of the active element 20 is radially arranged, at least partly, between the end surface 32 of the bottom wall 30 and wall 4 that delimits opening 6.

In other words, the expansion room 22 is concentric and arranged externally relative to the end surface 32 of the bottom wall 30.

Preferably, the bottom wall 30 exhibits an expansion duct 34 suitable for placing chamber 4 in fluid communication with the expansion room 22 of the active element 20.

In particular, the expansion duct 34 opens from the end surface 32 towards the expansion room 22.

Preferably, moreover, the expansion room 22 exhibits a section with radially extends, at least mainly, beyond the centre line of the longitudinal section of the sealing ring 12.

According to a preferred embodiment, the active element 20 further exhibits at least one annular seat obtained on said top surface 24 and said sealing means further comprise at least one secondary sealing ring 13, made of graphite, arranged in said annular seat of the active element 20.

Preferably, said secondary sealing ring 13 exhibits an inner side surface which axially faces stem 1, closer to the outer stem surface as compared to the inner side surface of the active element 20. In other words, the inner side surface of the active element 20 is diametrically external relative to the inner side surface of the secondary sealing ring 13.

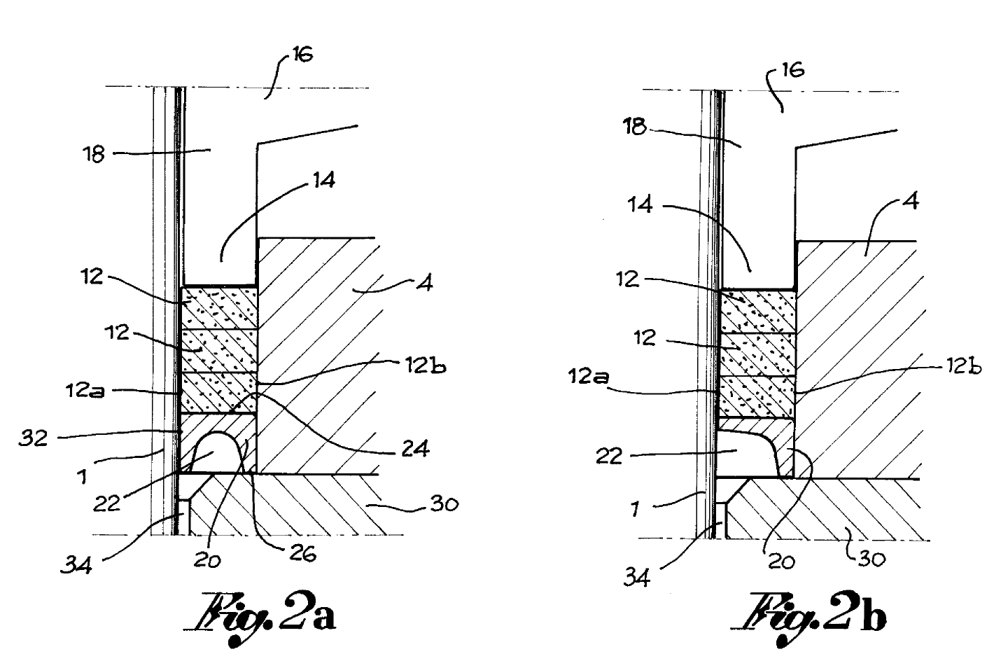

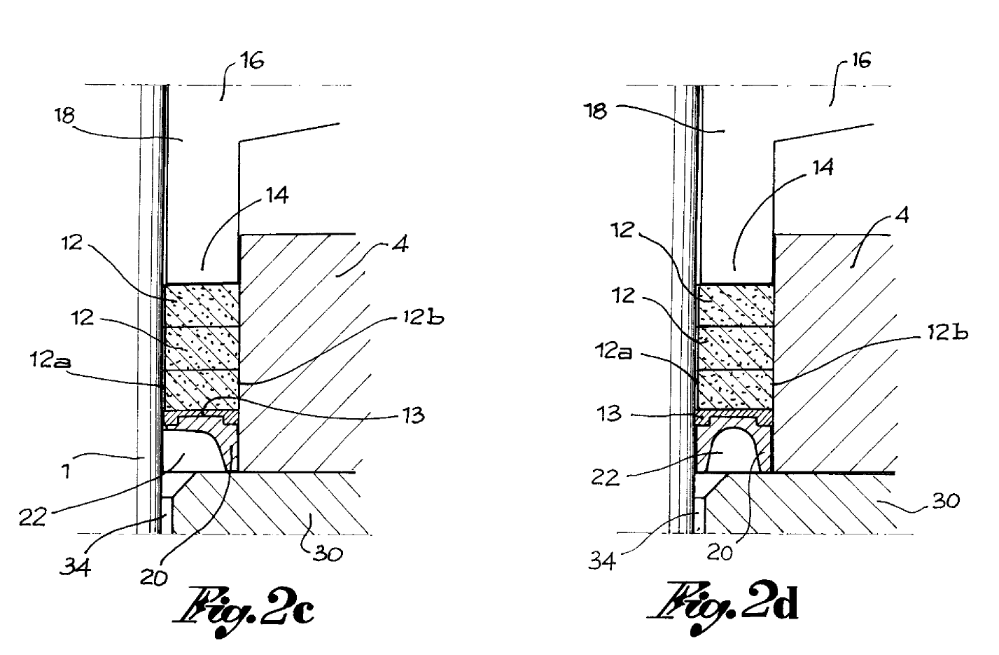

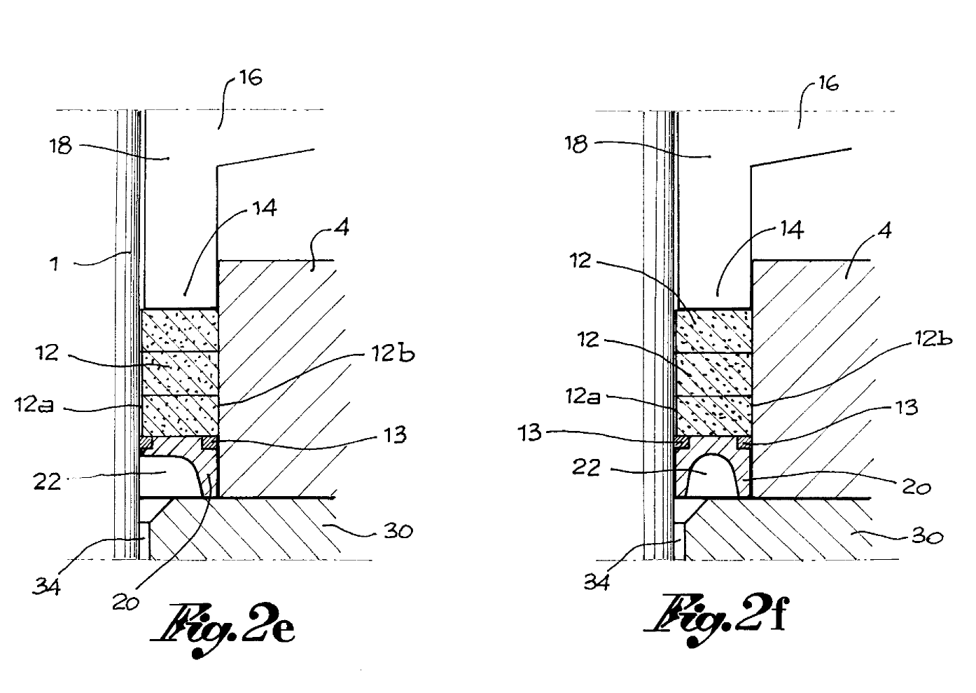

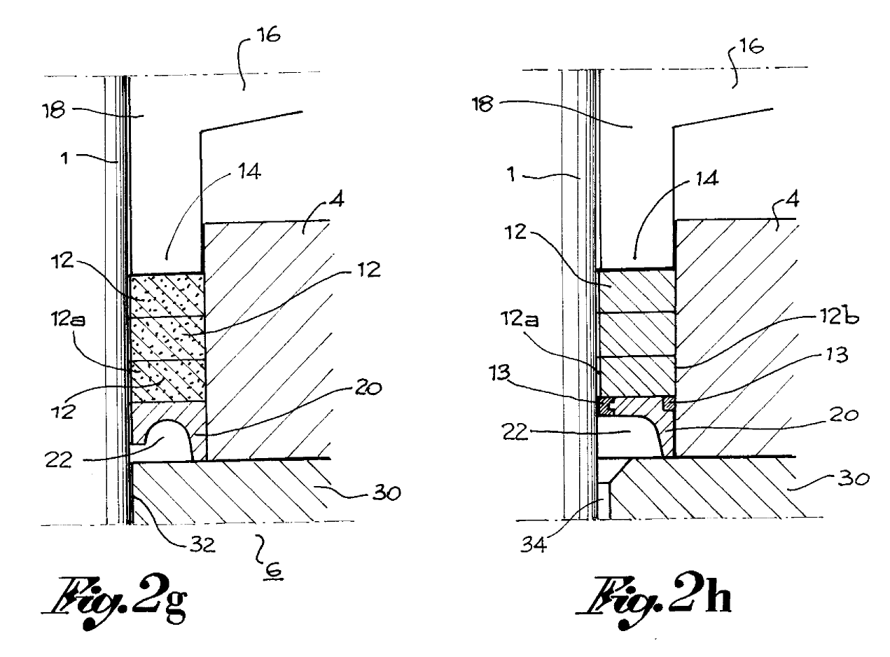

According to a further embodiment, the secondary sealing ring 13 arranges between the active element 20 and stem 1, like an inside sheath (FIG. 2h).

In the normal use of the valve, the sealing rings 12, piled and inserted in the gap between the stem and the wall of opening 6, are in compression between the abutment wall 14 of the gland device and the bottom wall 30.

For clarity of description, let's assume that the active element is made of steel, that is, virtually indeformable by the fluid pressure action, whereas the sealing rings are made of expanded graphite and thus strongly axially compressible and radially expansible.

The fluid present into chamber 2 of the valve exhibits a pressure due to the operating conditions of the system where the valve is installed.

The fluid, for example through the expansion duct 34, fills the expansion room 22 of the active element 20 and acts on such active element with a thrust action, irrespective of the shape of the expansion room 22.

As said, the active element transmits a thrust action to the sealing ring 12 in abutment with the active element itself.

The resulting thrust action promotes a strong compression of the bottom sealing rings. At the same time, since the expansion room 22 exhibits a prevailing section extending beyond the centre line of the section of the sealing ring, the active element 20 strains the first sealing ring 12 in the proximity of the outer radial surface 12b, relieving the ring compression against wall 4 that delimits opening 6 and increasing the compression towards the stem.

Innovatively, the device according to the present invention is provided with such sealing means as to ensure a better distribution of the strain state of the sealing rings.

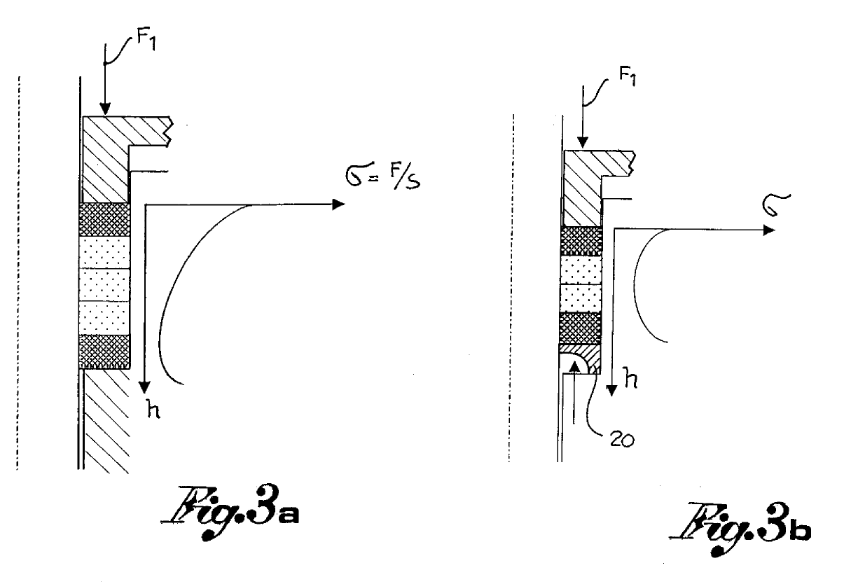

Advantageously, moreover, the provided sealing means allow achieving a high compression of the bottom rings too, usually little strained. Such distribution of the strains corresponds to a better use of the sealing rings and consequently, to the possibility of reducing the tightening loads on the gland device (FIGS. 3a and 3b).

Experimental measurements made by the Applicant have shown that the seal can be obtained using a pre-load through stud bolts which on the average is 50% less than in conventional systems.

According to a further advantageous aspect, the better use of the sealing rings allows the extension of the relaxation times of the ring material, thus ensuring long working life.

Such measurements have shown that the decrease of the torque resistant to the stem rotation after a large number of manoeuvres, which is an index of the material relaxation, has been measured as less of only 20% than the resistant torque measured at the beginning of the test.

According to an even further advantageous aspect, the more even distribution of the strain of the rings causes a lower resistant action on the stem mobility. For example, a lower torque that the operator must exert on the small ring of a valve to open or close it, or a lower resistance to the piston movement of a cylinder-piston, or a lower resistant torque to the rotation of a shaft, have been measured.

Such measurements have shown that the resistant torque to the stem rotation is on the average less by 30% to 50% than the resistant torque that can be measured in a conventional system.

Advantageously, moreover, the thrust action of the active element on the sealing ring is proportional to pressure, and therefore a self-adjusting effect obtained, based on which greater pressures correspond to a higher ring strain, irrespective of the pre-load initially assigned by the gland device.

In fact, the experimental measurements have confirmed that the above advantages are even stronger when the valve dimensions are larger and when the fluid pressure is higher.

According to a further advantageous aspect, the secondary sealing ring, made of graphite, when arranged between the active element and the stem, allows avoiding the occurrence of scratches on the stem.

According to an embodiment variation, said bottom containment wall 4 exhibits an expansion duct 34 suitable for placing said chamber 6 in fluid communication with said expansion room 22 of the active element 20.

What is claimed is:

1. A stem sealing arrangement for a device having
a containment wall defining a chamber for containing a fluid under pressure, wherein said wall has at least one opening leading to the environment outside said chamber, and
a stem at least partly housed in said chamber, wherein said stem has a stem axis and comprises a sealing portion arranged through said opening,
said stem sealing arrangement comprising:
at least one sealing ring installed on said stem, in an operating configuration of the device said sealing ring being radially compressed against said stem for forming a seal between the stem and the opening,
an abutment wall suitable for forming an axial abutment for said sealing ring, and
at least one active element arranged so as to be directly influenced by the action of the fluid pressure in said chamber, wherein said active element has at least one expansion room wherein the fluid pressure thrusts said active element towards said sealing ring.

2. A device according to claim 1, wherein said active element has a top surface in contact with said sealing ring and a bottom surface, axially opposite said top surface, wherein said expansion room opens.

3. A device according to claim 2, wherein said expansion room is annular and annularly uninterrupted.

4. A device according to claim 1, wherein said sealing means further comprise a bottom wall, inside said chamber, at least partly radially protruding from the wall that delimits said opening, said sealing ring and said active element being arranged between said abutment wall and said bottom wall.

5. A device according to claim 4, wherein said active element rests on said bottom wall.

6. A device according to claim 5, wherein said bottom wall exhibits an end surface that radially delimits said bottom wall, said end surface being axially facing said stem.

7. A device according to claim 6, wherein said expansion room is radially arranged, at least partly, between said end surface of the bottom wall and the wall that delimits said opening.

8. A device according to claim 6, wherein said bottom wall has an expansion duct suitable for placing said chamber in fluid communication with said expansion room of the active element.

9. A device according to claim 6, wherein said containment wall has an expansion duct suitable for placing said chamber in fluid communication with said expansion room of the active element.

10. A device according to claim 8, wherein said expansion duct opens from said end surface towards said expansion room.

11. A device according to claim 1, wherein said expansion room has a longitudinal section with extends, at least mainly, beyond the centre line of the longitudinal section of said sealing ring.

12. A device according to claim 1, wherein said active element is structurally suitable for causing a thrust action towards said sealing ring.

13. A device according to claim 12, wherein said active element is suitable to have a compression deformation which is less than the compression deformation of said sealing ring, strain conditions being equal.

14. A device according to claim 13, wherein said active element is made of an active material and said sealing ring is made of a sealing material, said active material being suitable to have a compression deformation which is less than the compression deformation of the sealing material, strain conditions being equal.

15. A device according to claim 13, wherein said sealing 5 ring is made of graphite.

16. A device according to claim 13, wherein said active element is made of steel.

17. A device according to claim 1, wherein said active element is a ring.

18. A device according to claim 1, wherein said sealing means comprise a plurality of piled sealing rings arranged in the gap between said stem and the wall that delimits said opening.

19. A device according to claim 18, wherein at least one 15 of said sealing rings is shaped as a braid.

20. A device according to claim 19, wherein said sealing ring shaped as a braid is directly in abutment with said abutment wall.

21. A device according to claim 4, comprising a gland device comprising said abutment wall, said gland device being suitable for compressing said sealing ring and said active element against said bottom wall.

22. A device according to claim 1, wherein said active element further has at least one annular seat obtained on said top surface.

23. A device according to claim 22, wherein said sealing means further comprise at least one secondary sealing ring arranged in said annular seat.

24. A device according to claim 23, wherein said secondary sealing ring is made of graphite.

25. A device according to claim 23, wherein said secondary sealing ring is arranged between said active element and said stem, like an inside sheath.

26. A device according to claim 1, wherein said device is a fluid on-off valve wherein said stem is the valve control stem for opening/closing said valve.

27. A device according to claim 1, wherein said device is a cylinder-piston system, said stem being the piston stem.

28. A device according to claim 1, wherein said stem is a rotatable shaft.
